(19) United States
(12) Patent Application Publication
(10) Pub. No.: US 2006/0125586 A1
(43) Pub. Date: Jun. 15, 2006

(54) Choke coil and embedded core thereof

(75) Inventors: Cheng-Hong Lee, Taoyuan Hsien (TW); Ming-Shan Shiu, Taoyuan Hsien (TW); Yi-Hong Huang, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/266,302

(22) Filed: Nov. 4, 2005

(30) Foreign Application Priority Data
Dec. 15, 2004 (CN) 2004101019514

(51) Int. Cl. H01F 27/02

(52) U.S. Cl. 336/83

(57) ABSTRACT

A choke coil includes an embedded core having a first core and a second core embedded within the first core, and a pair of coils wound around the first core and the second core. The first core and the second core are made of different materials which have different initial permeability (μᵢ). The second core has a gap filled with the same material as the first core. For example, the first core includes Fe-base magnetic metal or a Fe-based magnetic alloy for eliminating differential mode noise, and the second core includes ferrite for eliminating common mode noise. Thus, the choke coil can eliminate both common mode noise and differential mode noise at the same time and reduce the whole volume of the choke coil.

This Non-provisional application claims priority under U.S.C.§ 119(a) on Patent Application No(s). 200410101951.4 filed in China on Dec. 15, 2004, the entire contents of which are hereby incorporated by reference.

### BACKGROUND

The invention relates to a choke coil, and in particular to a choke coil capable of simultaneously eliminating both common mode noise and differential mode noise.

Electronic devices are commonly used nowadays. Most of the electronic devices are driven by electricity. A common type of electricity from plugs in the wall is called alternating current. Alternating current usually generates noise due to power supply, high-frequency transformer, or operation of the parasitic capacitance and stray capacitance of other components in the device, commonly referred to as electrical interference.

Generally, noise generated when using alternating current includes differential mode noise and common mode noise. EMI filters can be the first defense against electromagnetic radiation. An EMI filter is mainly composed of a choke coil and a capacitor, and the choke coil can restrain generation of noise or prevent noise from entering the electrical devices or electrical apparatuses. Referring to FIG. 1A, which shows a core 1 of a conventional choke coil. In FIG. 1, the core 1 of a chock coil consists of a coiled thin strip of an amorphous alloy, and has at least one cut air gap 2. In view of the disadvantages of the amorphous alloy like the operating frequency thereof to absorb noise being often lower than 100 kHz, and low resistance to DC-bias, the cut air gap 2 is formed in the core 1 in order to modify the resistance to DC-bias; however, the initial permeability(μᵢ) of the choke coil is greatly reduced.

FIGS. 1B and 1C are schematic views of another two conventional choke coils. As shown in FIG. 1B, three individual magnetic cores 11a, 11b and 11c are integrated to make up a choke coil 11 which can eliminate common mode noise. The cores 11a, 11b and 11c are made of oxide magnetic substance, and an insulating material or viscose is applied between each core to separate them from each other. Since the choke coil (2) is made of the oxide magnetic substance having the high permeability, the impedance in the low frequency band (10 kHz side) is large. Also, the permeability in the high frequency band (10 MHz side) is high due to the dimensional resonance phenomenon, and then the impedance is large. However, three cores joined together tend to increase overall volume of the choke coil, which is disadvantageous to miniaturization. Further, this type of choke coil eliminates only common mode noise, not differential mode noise.

As shown in FIG. 1C, the conventional choke coil includes two individual cores, an outer core 111 and an inner core 114 wound together by a coil 18. The outer core 111 is made of a material with a large magnetic permeability, such as ferrite or amorphous, and the inner core 114 is made of a material with a relative low magnetic permeability, such as dust core. Between the two cores 111 and 114, there is an insulating material keeping them isolated. The high permeability of the outer core 111 may eliminate common mode noise. Conversely, the low permeability of the inner core 114 may eliminate differential mode noise. Nevertheless, the arrangement of the independent cores maximizes the volume of the choke coil, which is adverse to miniaturization. Further, disposing the insulating material between the cores is costly in both material and time.

Therefore, in both economical and miniaturization of size considerations, a choke coil capable of eliminating both common mode noise and differential mode noise is desirous.

### SUMMARY

The present invention provides a choke coil capable of efficiently eliminating common mode noise and differential mode noise, saving cost and minimizing volume.

Accordingly, choke coils are provided. An exemplary embodiment of a choke coil includes an embedded core and a pair of coils. The embedded core includes a first core, a second core which is embedded in the first core, and the pair of coils is respectively wound around the first coil. The first core and the second core have different initial permeability (μᵢ). The second core has a gap filled with the same material as the first core.

The first core and the second core are ring-shaped. The first core includes a composite magnetic material, and the second core includes ferrite; alternatively, the first core includes ferrite and the second core includes a composite magnetic material. The composite magnetic material includes a magnetic filler and a polymer. The magnetic filler includes iron, cobalt, nickel or alloy powder thereof, or ferrite. Alternatively, the composite magnetic material may include Fe-based metallic powders or ferrite. Furthermore, the composite magnetic material may include a Fe-based magnetic metal and a thermosetting resin, or a Fe-based magnetic alloy and a thermosetting resin. The Fe-based magnetic metal is iron, and the Fe-based magnetic alloy is Fe—Si alloy, Fe—Ni alloy, Fe—Si—Al alloy or Mo—Fe—Ni alloy with less than 10 percent for non-magnetic material in the overall weight.

### DESCRIPTION OF THE DRAWINGS

The invention can be more fully understood by reading the subsequent detailed description and examples with references made to the accompanying drawings, wherein:

FIG. 1A is a schematic view of a core of a conventional choke coil;

FIGS. 1B and 1C are schematic views of another two conventional choke coils;

FIG. 2A is a schematic view of an embodiment of a choke coil;

FIG. 2B is a schematic view showing interior of a core in FIG. 2A;

FIG. 2C is a cross section along line A-A′ in FIG. 2B; and

FIG. 3 is a schematic view of another embodiment of a core.

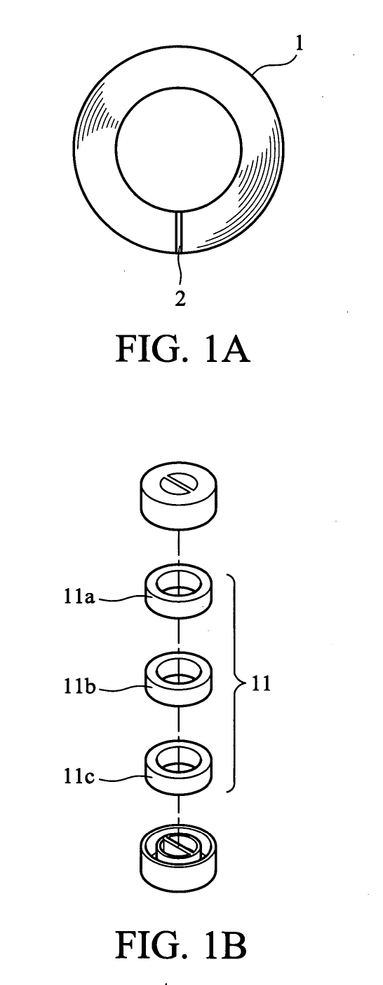

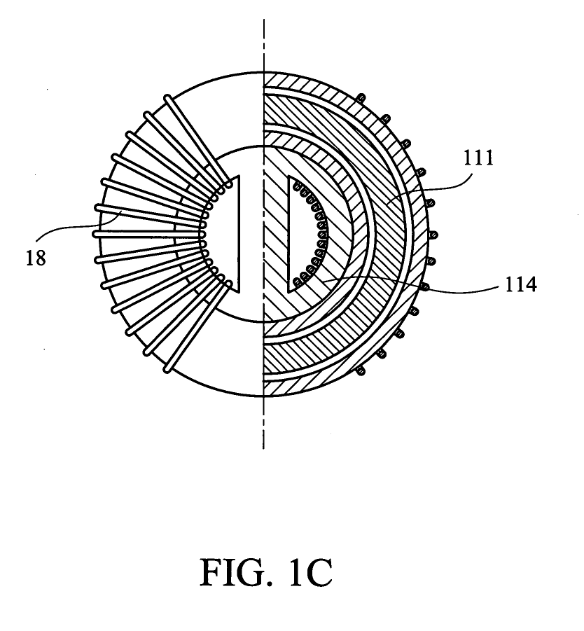

### DETAILED DESCRIPTION

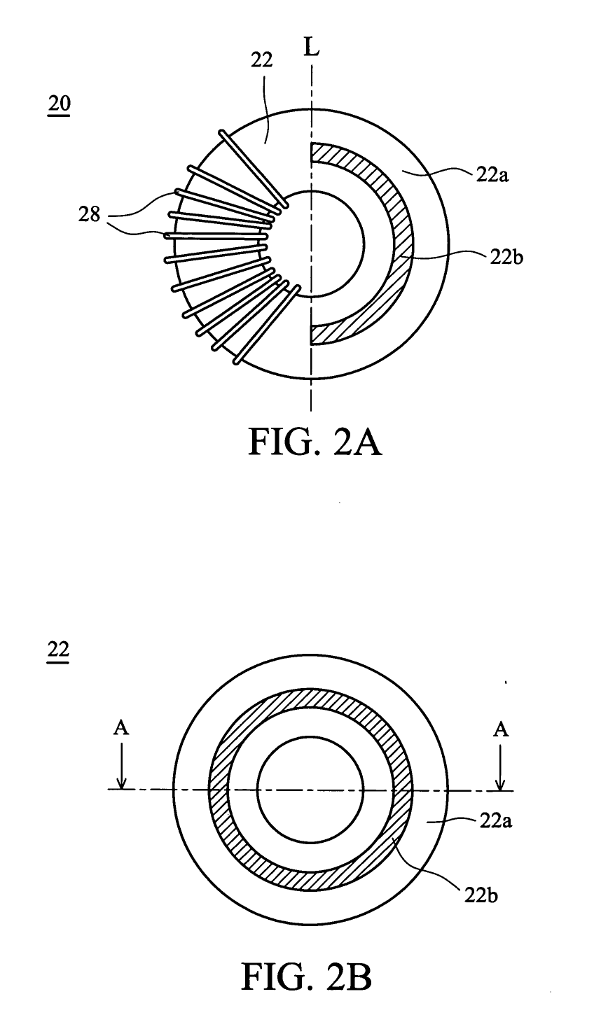

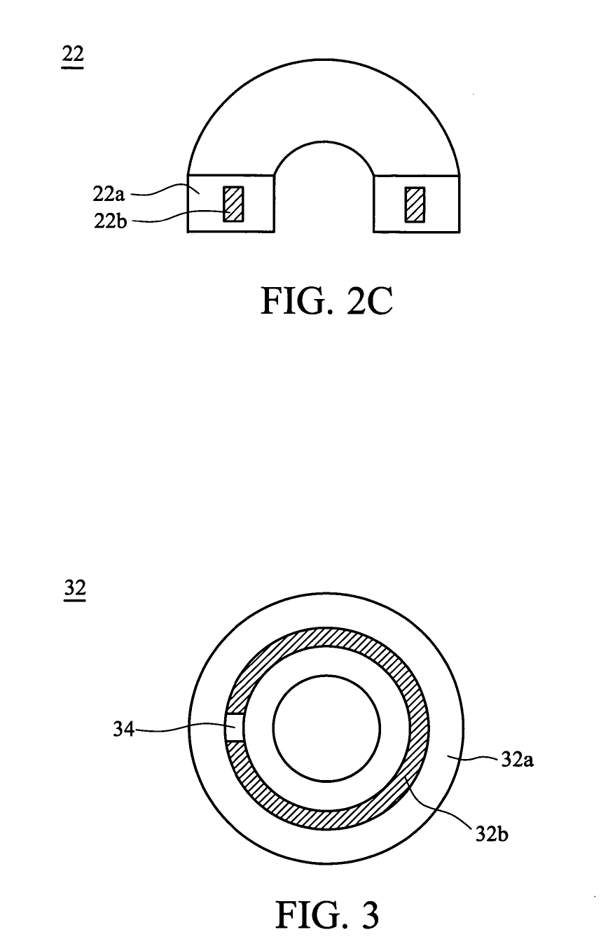

FIG. 2A shows an embodiment of a choke coil 20 including a core 22 and a pair of coils 28. For clear specification, according to an imaginary line L of FIG. 2A, the drawing is divided into two sides with the right side showing an inside view of the core and the left side showing the choke coil.

FIG. 2B shows an internal view of the core in FIG. 2A, and FIG. 2C is a sectional view along line A-A′ in FIG. 2B. Referring to FIGS. 2A, 2B and 2C, the core 22 includes a first core 22a and a second core 22b. The second core 22b is embedded in the first core 22a while the pair of coils 28 is wound separately around the first core 22a. The design of the embedded second core 22b reduces whole volume to aid miniaturization.

The first core 22a and the second core 22b are ring-shaped and are made by injection molding or by powder compression molding. The second core 22a is embedded in the first core 22a. It is worth noting that the shape of the first core 22a and the shape of the second core 22b are not limited to ring shape (as shown in FIG. 2A), and may be other shapes, such as eclipse, half circle, triangle, quadrangle, rectangle, trapezoid, pentagon, hexagon, octagon, or polygon with equal or unequal sides.

The first core 22a and the second core 22b are made of different material having different initial permeability (μᵢ). For example, the first core 22a is made of a composite magnetic material, and the second core 22b includes ferrite. The composite magnetic material includes a magnetic filler and a polymer. The magnetic filler includes iron(Fe), cobalt(Co), nickel(Ni) or alloy powder thereof, or ferrite. Alternatively, the composite magnetic material includes a Fe-based magnetic metal and a thermosetting resin, or a Fe-based alloy and a thermosetting resin. For example, the Fe-based magnetic metal may be iron, and the Fe-based magnetic alloy may be Fe—Si alloy, Fe—Ni alloy, Fe—Si—Al alloy, or Mo—Fe—Ni alloy, preferably wherein the alloy contains less than 10 weight percent of non-magnetic element.

When the first core 22a is made of the composite magnetic material, the first core 22a has a lower magnetic permeability than the second core 22b so as to filter differential mode noise. On the other hand, the second core 22b made of ferrite has a high magnetic permeability so as to filter common mode noise. Thus, only the single choke coil is capable of eliminating both common mode and differential mode noise, at reduced costs and volume.

Further, the material of the first core 22a can be exchanged with the material of the second core 22b, such that the first core 22a includes ferrite and the second core are made of a composite magnetic material. In other words, the magnetic permeability of the first core 22a can exceed that of the second core 22b. In this case, the first core 22a filters common mode noise while the second core 22b filters differential mode noise.

FIG. 3 shows a schematic view of another embodiment of a core 32. Unlike the embodiment in FIG. 2A, the second core 32b of the core 32 in FIG. 3 has a gap 34 filled by the same material as the first core 32a. The core 32 includes the first core 32a and the second core 32b, and the second core 32b is embedded in the first core 32a. The gap 34 of the second core 32b is filled with the same material as the first core 32a. By controlling the size of the gap 34, properties of the choke coil can be adjusted, for example, operation frequency, inductance, and resistance to DC-bias.

The conventional core including ferrite with an air gap in the core may increase resistance to DC-bias; however, the air gap filled up with air also decreases the inductance. On the contrary, material in the gap 34 is the same material of the first core 32a, and the initial permeability for that material exceeds the initial permeability of air. Therefore, the property of the core 32 is adjustable by the size of the gap 34 of the second core 32b. Also, it's the inductance of the core 32 is kept high. Furthermore, the choke coil of the present invention is preferably used in a filter module, a power supply, or other electronic devices that may generate noise.

It should be noted that the embedded core of the present invention is not limited to the above embodiments. The embedded core may also be used in manufacturing inductors which can accomplish miniaturization of the inductors.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An embedded core, comprising:
a first core; and
a second core, embedded in the first core;
wherein the first core and the second core have different initial permeability (μᵢ).

2. The embedded core as claimed in claim 1, wherein the second core has a gap filled with the same material as the first core.

3. The embedded core as claimed in claim 1, wherein the first core and the second core are ring-shaped.

4. The embedded core as claimed in claim 1, wherein the first core and the second core comprise ferrite or a composite magnetic material, respectively.

5. The embedded core as claimed in claim 4, wherein the composite magnetic material comprises a magnetic filler and a polymer.

6. The embedded core as claimed in claim 5, wherein the magnetic filler comprises iron, cobalt, nickel or alloys thereof, or ferrite.

7. The embedded core as claimed in claim 4, wherein the composite magnetic material comprises a thermosetting resin with a Fe-based magnetic metal, or a thermosetting resin with an Fe-based magnetic alloy.

8. The embedded core as claimed in claim 7, wherein the Fe-based magnetic metal is iron, and the Fe-based magnetic alloy is Fe—Si alloy, Fe—Ni alloy, Fe—Si—Al alloy, or Mo—Fe—Ni alloy.

9. The embedded core as claimed in claim 7, wherein the Fe-based magnetic alloy contains less than 10 weight percent of non-magnetic element.

10. The embedded core as claimed in claim 1, wherein the first core and the second core are formed by injection molding or by powder compression molding.

11. A choke coil comprising:
an embedded core comprising a first core and a second core embedded in the first core; and
a pair of coils, wound around the first core; wherein the first core and the second core have different initial permeability (μᵢ).

12. The choke coil as claimed in claim 11, wherein the second core has a gap filled with the same material as the first core.

13. The choke coil as claimed in claim 11, wherein the first and the second cores are ring-shaped.

14. The choke coil as claimed in claim 11, wherein the first core and the second core comprise ferrite or a composite magnetic material, respectively.

15. The choke coil as claimed in claim 14, wherein the composite magnetic material comprises a magnetic filler and a polymer.

16. The choke coil as claimed in claim 15, wherein the magnetic filler comprises iron, cobalt, nickel or alloys thereof, or ferrite.

17. The choke coil as claimed in claim 16, wherein the composite magnetic material comprises a thermosetting resin and a Fe-based metal, or a thermosetting resin and a Fe-based magnetic alloy.

18. The choke coil as claimed in claim 17, wherein the Fe-based magnetic metal is iron, and the Fe-based magnetic alloy is Fe—Si alloy, Fe—Ni alloy, Fe—Si—Al alloy, or Mo—Fe—Ni alloy.

19. The choke coil as claimed in claim 17, wherein the Fe-based alloy contains less than 10 weight percent of non-magnetic element.

20. The choke coil as claimed in claim 15, wherein the first core and the second are made by injection molding process or by powder compression molding.
